(19) United States
(12) Patent Application Publication
(10) Pub. No.: US 2025/0005408 A1
(43) Pub. Date: Jan. 2, 2025

(54) BAYESIAN OPTIMIZATION DEVICE, BAYESIAN OPTIMIZATION METHOD, AND BAYESIAN OPTIMIZATION PROGRAM

(71) Applicant: NIPPON TELEGRAPH AND TELEPHONE CORPORATION, Tokyo (JP)

(72) Inventors: Yuki KURAUCHI, Tokyo (JP); Masahiro KOJIMA, Tokyo (JP)

(73) Assignee: NIPPON TELEGRAPH AND TELEPHONE CORPORATION, Tokyo (JP)

(21) Appl. No.: 18/705,737

(22) PCT Filed: Nov. 15, 2021
(86) PCT No.: PCT/JP2021/041921

§ 371 Date: Apr. 29, 2024

(51) Int. Cl. G06N 7/01

(52) U.S. Cl. CPC G06N 7/01

(57) ABSTRACT

A Bayesian optimization device includes: a comparison result developing unit configured to receive and develop comparison results input by a user; a comparison result storing unit configured to store the developed comparison results; a model learning unit configured to learn a model on the basis of the developed comparison results;
a model storing unit configured to store the learned model; a candidate point selecting unit configured to select a candidate point for search on the basis of the developed comparison results and the learned model; and a candidate point presenting unit configured to present the candidate point for search to the user.

### TECHNICAL FIELD

The present invention relates to a Bayesian optimization device, a Bayesian optimization method, and a Bayesian optimization program.

### BACKGROUND ART

Personalization is often used in a field in which a mechanism for collecting personal data is likely to be created. For example, personalization of products, content, services, and advertisements from browsing, playback, clicks, purchases, and evaluation logs has been performed.

On the other hand, personalization is not general in a field in which a mechanism for collecting personal data is less likely to be created. For example, it is not general to perform personalization of how one feels about something, which is represented by estimation of emotions and likability from facial expressions, gestures, and voices, or evaluation of five senses such as how aromas, tastes, and favorability of food and drinks are perceived.

If personalization targeting such subjective data is realized, for example, utilization such as converting facial expressions in accordance with emotion recognition characteristics of a certain person A to convey emotions correctly, or making dishes that a certain person A likes most is conceivable.

From the above, a method for efficiently collecting subjective data for easily building a model relating to subjective data is required.

### CITATION LIST

### Non Patent Literature

[NPL 1] B. Shahriari, K. Swersky, Z. Wang, R. Adams, and N. de Freitas: Taking the human out of the loop: A Review of Bayesian Optimization. Proc. Of the IEEE, (1), December 2015 (2016)
[NPL 2] Google. “The makings of a smart cookie.” https://www.blog.google/technology/research/makings-smart-cookie/, 2017.
[NPL 3] Chu, Wei, et. al. “Preference learning with Gaussian processes.” “Proc. of the 22nd International conference on Machine Learning, 2005.
[NPL 4] Niranjan Srinivas, et. al. “Information-theoretic regret bounds for gaussian process optimization in the bandit setting”, IEEE Transactions on Information Theory, vol. 58, No. 5, pp. 3250-3265, 2010.
[NPL 5] Jonas Mockus, et. al. “The application of Bayesian methods for seeking the extremum”, Towards Global Optimisation, Vol. 2, pp. 117-129, 1978.
[NPL 6] Emile Contal, et. al. “Gaussian Process Optimization with Mutual Information”, International Conference on Machine Learning, pp. 253-261, 2014.

### SUMMARY OF INVENTION

### Technical Problem

NPL 1 discloses Bayesian optimization as a method for collecting a small amount of data to build a model.

Bayesian optimization is a mechanism for repeatedly learning presentation of parameters for search by inputting a score for a certain parameter.

For example, when a user scores a dish of a certain recipe, a recipe to be evaluated next is output, the user scores it, and these operations are repeated, whereby a recipe that maximizes the user's evaluation is output finally.

NPL 2 discloses an example in which a recipe of a cookie is optimized using Bayesian optimization.

However, when subjective data is collected, there is a problem of large fluctuations in user scores.

NPL 3 proposes a learning method using a Gaussian process with comparison results serving as an input in order to solve a problem of fluctuations in user scores.

This method is a mechanism for repeatedly learning presentation of a parameter for search using comparison results between a parameter selected last time and a presented parameter as an input. The parameter selected last time is a parameter with the highest evaluation ever.

Here, the presented parameter is a parameter for search, and the parameter selected last time is a parameter to be compared with the presented parameter, that is, the parameter for search. In the following description, the parameter for search is also referred to as a candidate point for search, a new candidate point, or simply a candidate point, and the parameter to be compared with the parameter for search is also referred to as a comparison point.

For example, when a user selects dishes of two recipes in order, a recipe to be compared next is output, the user selects a recipe highly evaluated last time and the output recipe to be compared in order, and these operations are repeated, whereby a recipe that maximizes the user's evaluation is output finally.

However, this method has a problem that it takes time to converge and the number of times of comparison performed by the user is large.

The present invention has been made by paying attention to the above circumstances, and an object thereof is to provide a Bayesian optimization device, a Bayesian optimization method, and a Bayesian optimization program in which learning converges faster and the number of times of comparison performed by a user is reduced.

### Solution to Problem

An aspect of the present invention is a Bayesian optimization device. The Bayesian optimization device includes: a comparison result developing unit configured to receive and develop comparison results input by a user; a comparison result storing unit configured to store the developed comparison results; a model learning unit configured to learn a model on the basis of the developed comparison results; a model storing unit configured to store the learned model; a candidate point selecting unit configured to select a candidate point for search on the basis of the developed comparison results and the learned model; and a candidate point presenting unit configured to present the candidate point for search to the user.

An aspect of the present invention is a Bayesian optimization method. The Bayesian optimization method includes: receiving and developing comparison results input by a user; storing the developed comparison results; learning a model on the basis of the developed comparison results; storing the learned model; selecting a candidate point for search on the basis of the developed comparison results and the learned model; and presenting the candidate point for search to the user.

A Bayesian optimization program according to an aspect of the present invention causes a computer to execute functions of each of constituent elements of the Bayesian optimization device.

### Advantageous Effects of Invention

According to the present invention, the Bayesian optimization device, the Bayesian optimization method, and the Bayesian optimization program in which learning converges faster and the number of times of comparison performed by a user is reduced are provided.

### BRIEF DESCRIPTION OF DRAWINGS

FIG. 1 is a block diagram showing an example of a functional configuration of a Bayesian optimization device according to an embodiment.

FIG. 2 is a diagram showing an example of comparison result data received by a comparison result developing unit in the Bayesian optimization device according to the embodiment.

FIG. 3 is a diagram showing an example of developed comparison results output by the comparison result developing unit in the Bayesian optimization device according to the embodiment.

FIG. 4 is a schematic diagram showing a state of comparison result development performed by the comparison result developing unit in the Bayesian optimization device according to the embodiment.

FIG. 5 is a block diagram showing an example of a hardware configuration of the Bayesian optimization device according to the embodiment.

FIG. 6 is a flowchart showing operations of the Bayesian optimization device according to the embodiment.

FIG. 7 is a block diagram showing an example of a functional configuration of a Bayesian optimization device according to a known example.

FIG. 8 is a diagram showing an example of comparison result data stored in a comparison result storing unit in the Bayesian optimization device according to the known example.

FIG. 9 is a schematic diagram a state of comparison in the Bayesian optimization device according to the known example.

### DESCRIPTION OF EMBODIMENTS

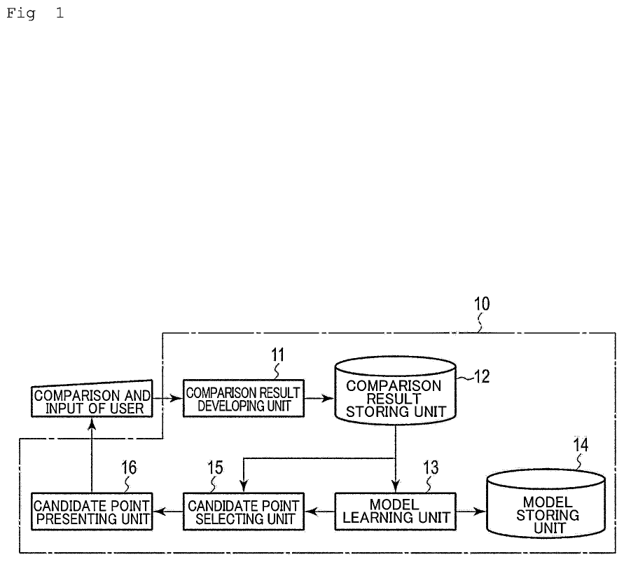

An embodiment according to the present invention will be described below with reference to the drawings. FIG. 1 is a block diagram showing an example of a functional configuration of a Bayesian optimization device 10 according to the embodiment.

As shown in FIG. 1, the Bayesian optimization device 10 has a comparison result developing unit 11, a comparison result storing unit 12, a model learning unit 13, a model storing unit 14, a candidate point selecting unit 15, and a candidate point presenting unit 16.

The comparison result developing unit 11 receives comparison results input by a user and develops the received comparison results. The comparison result developing unit 11 also outputs the developed comparison results to the comparison result storing unit 12.

The comparison result storing unit 12 receives the developed comparison results from the comparison result developing unit 11 and stores them.

The model learning unit 13 reads the developed comparison results from the comparison result storing unit 12 and reads a model from the model storing unit 14. The model learning unit 13 learns the model on the basis of the comparison results. The model learning unit 13 also outputs the learned model to the model storing unit 14.

The model storing unit 14 stores an unlearned model in an initial state. Each time the model learning unit 13 executes learning of the model, the model storing unit 14 receives the learned model from the model learning unit 13 and stores it. In other words, the model storing unit 14 updates the stored model.

The candidate point selecting unit 15 reads the comparison results from the comparison result storing unit 12 and reads the learned model from the model learning unit 13. The candidate point selecting unit 15 also selects a candidate point for search on the basis of the comparison results and the learned model. The candidate point selecting unit 15 also outputs the candidate point for search to the candidate point presenting unit 16.

The candidate point presenting unit 16 receives the candidate point for search from the candidate point selecting unit 15 and presents it to the user.

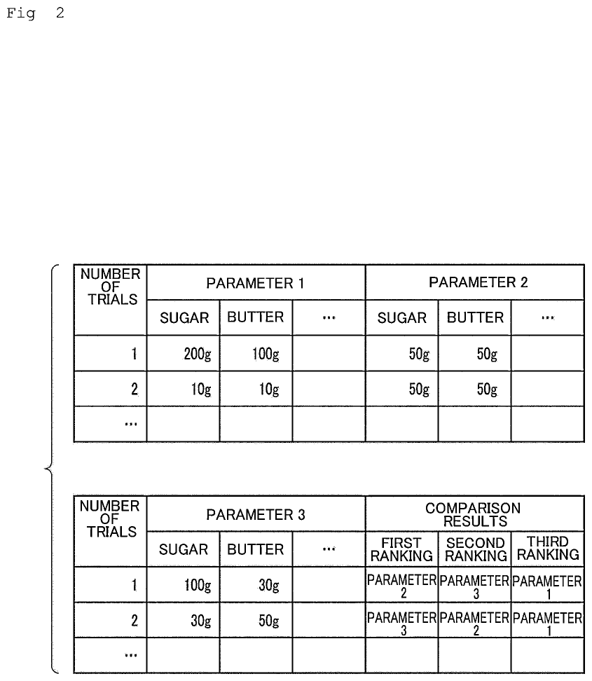

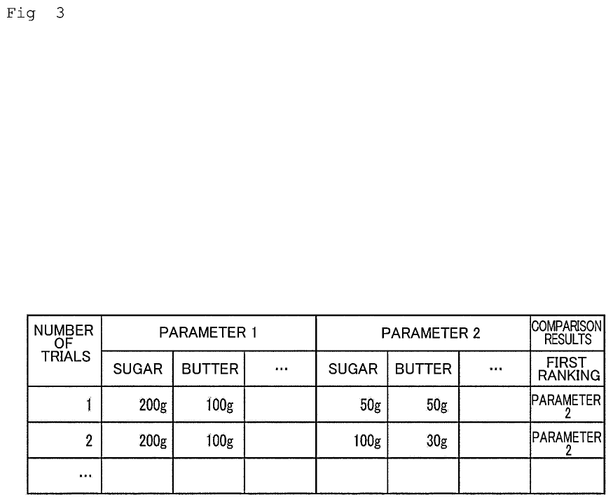

FIG. 2 is a diagram showing an example of comparison result data input by the user to the comparison result developing unit 11. In addition, FIG. 3 is a diagram showing an example of developed comparison result data output by the comparison result developing unit. In FIGS. 2 and 3, the comparison result data is expressed in a table format. Also, in FIG. 2, the comparison result data is drawn as a two-stage table for convenience.

The comparison result data of FIGS. 2 and 3 is examples of cookie recipe data and has a plurality of parameters. Each parameter has information of sugar, butter, and so on. The comparison result data also includes information about the comparison results for each number of trials.

The comparison results input by the user input to the comparison result developing unit 11 have three or more parameters and their comparison results. The comparison result data of FIG. 2 is data when the number of parameters is three. For this reason, the comparison result data of FIG. 2 has Parameter 1, Parameter 2, and Parameter 3. The comparison result data of FIG. 2 also has information about first, second, and third ranking parameters for each number of trials as the comparison results.

The comparison result data of FIG. 3 is data having two parameters, that is, parameters 1 and 2. The comparison result data of FIG. 3 also includes information about the first ranking parameter for each number of trials as the comparison results.

The comparison result developing unit 11 develops the comparison result data of FIG. 2 to create the comparison result data of FIG. 3. First, the comparison result developing unit 11 compares Parameters 1, 2, and 3 of the comparison result data of FIG. 2 with each other to acquired three comparison results. The three comparison results are a first comparison result which is a comparison result between Parameter 1 and Parameter 2, a second comparison result which is a comparison result between Parameter 2 and Parameter 3, and a third comparison result which is a comparison result between Parameter 3 and Parameter 1. Next, the comparison result developing unit 11 performs ranking on the basis of these three comparison results to create the comparison result data of FIG. 3

Next, a hardware configuration of the Bayesian optimization device 10 will be described. The Bayesian optimization device 10 is configured by a computer. For example, the Bayesian optimization device 10 is configured by a personal computer, a server computer, or the like.

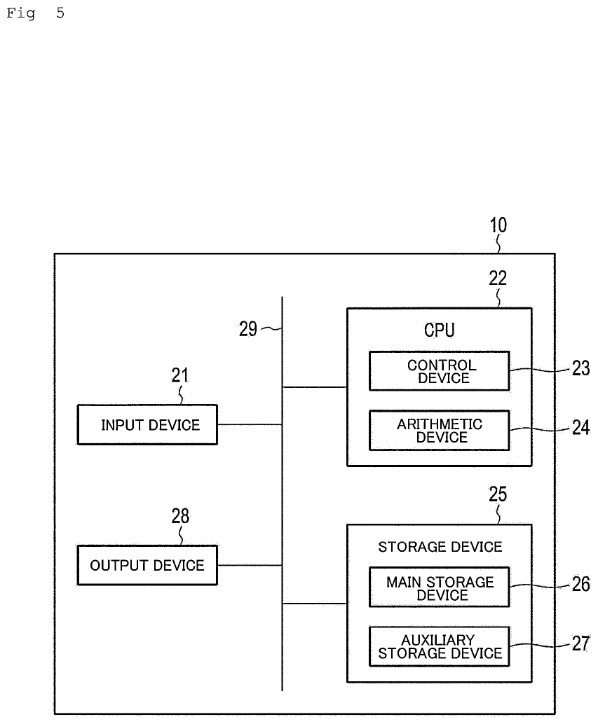

FIG. 5 is a block diagram showing an example of the hardware configuration of the Bayesian optimization device 10 according to the embodiment. As shown in FIG. 5, the Bayesian optimization device 10 has an input device 21, a CPU 22, a storage device 25, and an output device 28. The Bayesian optimization device 10 may further have other peripheral devices in addition to them.

The input device 21, the CPU 22, the storage device 25 and the output device 28 are electrically connected to each other via a bus 29, and perform exchange of data and commands via the bus 29.

The input device 21 is a device that receives data and commands from the user. For example, the input device 21 is configured of a keyboard, mouse, or the like. The input device 21 is not limited thereto and may be configured of any other input device.

The output device 28 is a device that presents data to the user. For example, the output device 28 is configured of a display. The output device 28 is not limited thereto and may be configured of any other output device.

The storage device 25 stores programs and data needed for processing executed by the CPU 22. The CPU 22 performs various processing by reading and executing needed programs and data from the storage device 25.

The storage device 25 has a main storage device 26 and an auxiliary storage device 27. The main storage device 26 and the auxiliary storage device 27 perform exchange of programs and data between them.

The main storage device 26 stores programs and data temporarily needed for processing of the CPU 22. For example, the main storage device 26 is configured of a volatile memory such as a random access memory (RAM).

The auxiliary storage device 27 stores programs and data supplied via external equipment or a network and provides the main storage device 26 with programs and data temporarily needed for processing of the CPU 22. The auxiliary storage device 27 is a hard disk drive (HDD), a solid state drive (SSD), or the like.

The CPU 22 is a processor and is hardware for processing data and commands. The CPU 22 has a control device 23 and an arithmetic device 24.

The control device 23 controls the input device 21, the arithmetic device 24, the storage device 25, and the output device 28.

The arithmetic device 24 reads programs and data from the main storage device 26, executes the programs to process the data, and provides the processed data to the main storage device 26.

In such a hardware configuration, the input device 21, the CPU 22, and the main storage device 26 form the comparison result developing unit 11. In addition, the storage device 25 forms the comparison result storing unit 12 and the model storing unit 14. The CPU 22 and the main storage device 26 form the model learning unit 13 and the candidate point selecting unit 15. The CPU 22, the main storage device 26, and the output device 28 form the candidate point presenting unit 16.

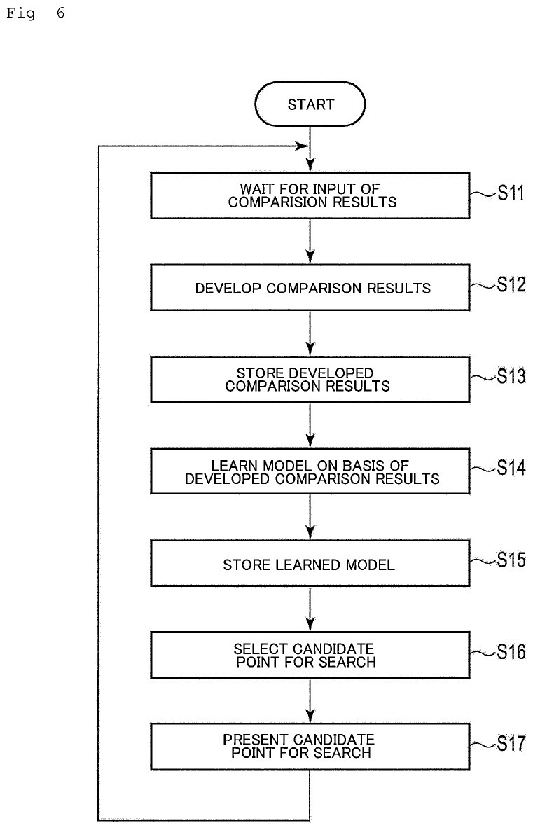

Next, operations of the Bayesian optimization device 10 will be described with reference to FIG. 6. FIG. 6 is a flowchart showing operations of the Bayesian optimization device 10.

In step S11, the comparison result developing unit 11 waits for a user to input the comparison results. When the comparison result developing unit 11 receives the comparison results input by the user, it proceeds with processing of step S12. The comparison results input by the user includes three or more parameters.

In step S12, the comparison result developing unit 11 develops the comparison results. That is, the comparison result developing unit 11 compares three or more parameters of the received comparison results with each other to create the developed comparison results. For example, the comparison result developing unit 11 receives the comparison results including three parameters as shown in FIG. 2 and creates the developed comparison results including two parameters as shown in FIG. 3. The comparison result developing unit 11 outputs the developed comparison results to the comparison result storing unit 12.

In step S13, the comparison result storing unit 12 receives the developed comparison results from the comparison result developing unit 11 and stores them.

In step S14, the model learning unit 13 reads the developed comparison results from the comparison result storing unit 12 and reads the model from the model storing unit 14. The model learning unit 13 learns the model on the basis of the developed comparison results. The model learning unit 13 also outputs the learned model to the model storing unit 14 and the candidate point selecting unit 15.

In step S15, the model storing unit 14 receives the learned model from the model learning unit 13 and stores it.

In step S16, the candidate point selecting unit 15 reads the developed comparison results from the comparison result storing unit 12 and receives the learned model from the model learning unit 13. The candidate point selecting unit 15 also selects the candidate point for search on the basis of the developed comparison results and the learned model. The candidate point selecting unit 15 outputs the candidate point for search to the candidate point presenting unit 16.

In step S17, the candidate point presenting unit 16 receives the candidate point for search from the candidate point selecting unit 15 and presents it to the user. After that, Bayesian optimization device 10 returns to the processing of step S11.

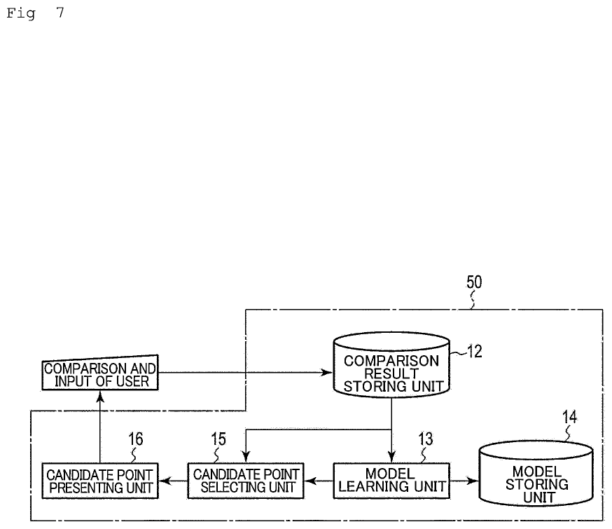

The Bayesian optimization device 10 according to the embodiment and a Bayesian optimization device 50 according to a known example will be compared with each other and discussed below. FIG. 7 is a block diagram showing an example of a functional configuration of the Bayesian optimization device 50 according to the known example. In FIG. 7, functional configurations with the same reference numerals as the functional configurations in FIG. 1 represents the same functional configurations.

As can be seen by comparing FIG. 7 with FIG. 1, the Bayesian optimization device 50 according to the known example has a configuration in which the comparison result developing unit 11 is omitted from the Bayesian optimization device 10 according to the embodiment. Along with this, the comparison result storing unit 12 according to the known example is configured to include the input device 21 and the CPU 22 in addition to the storage device 25 in terms of hardware.

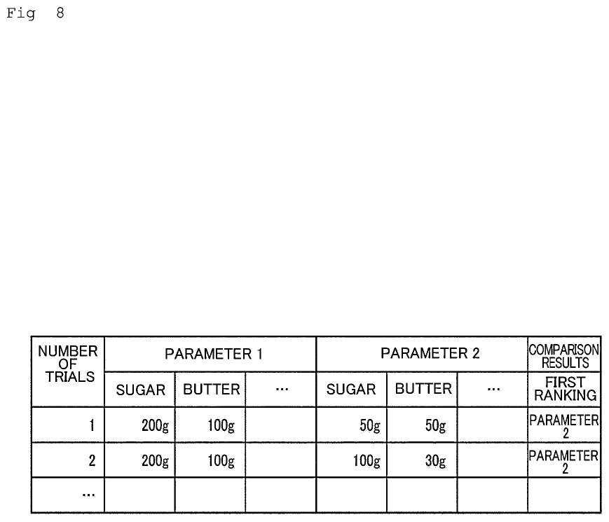

FIG. 8 is a diagram showing an example of comparison result data stored in the comparison result storing unit 12 in the Bayesian optimization device 50 of FIG. 7. The comparison result data of FIG. 8 is an example of recipe data of cookies, as in the comparison result data of FIG. 2 and FIG. 3 and is expressed in a table form.

The comparison result data of FIG. 8 has two parameters, that is, Parameters 1 and 2, and the comparison results. Each parameter has information of sugar, butter, and so on. The comparison results has information about the first ranking parameter for each number of trials.

As can be seen by comparing FIG. 8 with FIG. 3, the comparison result data of FIG. 8 is the same data as the comparison result data of FIG. 3.

In the Bayesian optimization device 50 according to the known example, the comparison results input by the user having two parameters is input to the comparison result storing unit 12. The model learning unit 13 learns the model on the basis of the comparison results. The candidate point selecting unit 15 selects the candidate point for search on the basis of the comparison results and the learned model. The candidate point presenting unit 16 presents the candidate point for search to the user. After that, the comparison result storing unit 12 waits for the user to input the next comparison result. By repeating this, Bayesian optimization is performed.

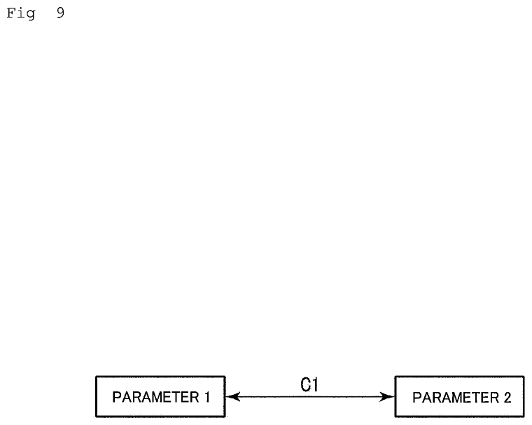

FIG. 9 is a schematic diagram showing a state of comparison in the Bayesian optimization device 50 according to the known example. The comparison result input by the user to the Bayesian optimization device 50 has two parameters, that is, Parameters 1 and 2. The comparison result obtained by comparing Parameter 1 with Parameter 2 is only one comparison result C1.

On the other hand, in the Bayesian optimization device 10 according to the embodiment, the comparison results input by the user having three or more parameters are input to the comparison result developing unit 11. The comparison result developing unit 11 compares the three or more parameters with each other to create the developed comparison results. The developed comparison results are comparison results each having two parameters as shown in FIG. 3. The developed comparison results are stored in the comparison result storing unit 12. The model learning unit 13 learns the model on the basis of the developed comparison results. The candidate point selecting unit 15 selects the candidate point for search on the basis of the comparison results and the learned model. The candidate point presenting unit 16 presents the candidate point for search to the user. After that, the comparison result developing unit 11 waits for the user to input the next comparison result. By repeating this, Bayesian optimization is performed.

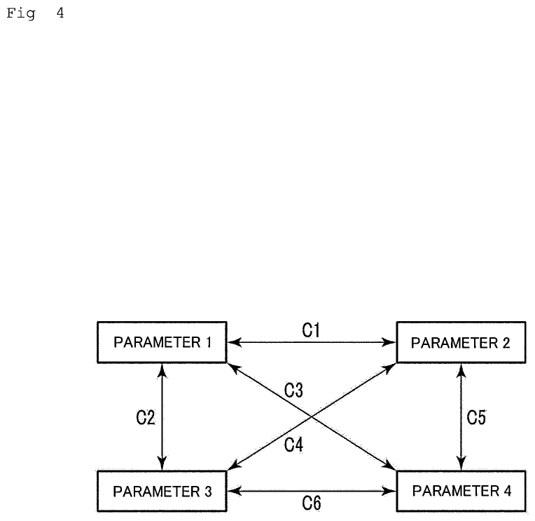

FIG. 4 is a schematic diagram showing a state of comparison result development performed by the comparison result developing unit 11 in the Bayesian optimization device 10 according to the embodiment. The comparison results input by the user to the comparison result developing unit 11 have three or more parameters. FIG. 4 shows a case in which the number of parameters is four. The comparison result developing unit 11 compares Parameter 1, Parameter 2, Parameter 3, and Parameter 4 with each other. As a result, the comparison result developing unit 11 obtains ₄C₂=6 comparison results C1, C2, C3, C4, C5 and C6.

As described above, in the Bayesian optimization device 10 according to the embodiment, model learning is performed on the basis of six comparison results acquired by comparing four parameters with each other, and thus the model learning is ideally expected to converge six times faster than the Bayesian optimization device 50 according to the known example in which model learning is performed by comparing two parameters with each other. In other words, it is expected that the number of times of comparison performed by the user is reduced to ⅙.

In the following, a more generalized case will be discussed in which the comparison results input by the user that are received by the comparison result developing unit 11 includes N parameters. Here, N is a natural number of 3 or more.

The comparison result developing unit 11 acquires _{N}C₂ comparison results by comparing the N parameters with each other, ranks them on the basis of the _{N}C₂ comparison results, and creates the developed comparison results. The model learning unit 13 learns the model on the basis of the developed comparison results. For this reason, learning converges faster and the number of times of comparison performed by the user is reduced.

The comparison result developing unit 11 selects M new candidate points and N-M comparison points for the N parameters of the comparison results by the user. Here, M is a natural number equal to or greater than 1 and less than N.

Examples of how to select the N-M comparison points are, for example, as follows.

(1) Select N-M comparison points with the highest evaluation from the past comparisons.

(2) Randomly select N-M comparison points from the past comparisons.

(3) Select N-M comparison points that are far from the new candidate points (for example, the squared distance) from the past comparisons.

Here, setting of a value of N will be described. As N is increased, more comparison results are obtained. As a result, learning converges faster and the number of times of comparison performed by the user is reduced. On the other hand, burdens on the user are increased. In consideration of these, N is preferably 10 or less, for example.

Next, setting of a value of M will be described. When M is reduced, the number of new candidate points to be added at one time is reduced. As a result, since many comparison results between the new candidate points and the comparison points are obtained, inference performance is improved. On the other hand, the computational cost increases.

For this reason, both the value of N and the value of M may be determined in the trade-off of performance and cost.

The search of the new candidate points in the comparison result developing unit 11 and the candidate point selecting unit 15 is performed using the upper confidence bound algorithm disclosed in NPL 4, the expected improvement algorithm disclosed in NPL 5, the mutual information algorithm disclosed in NPL 6, or the like.

Next, the model and learning in the model learning unit 13 will be described. A Gaussian process is used for the model, and learning is performed using the following likelihood function.

### [Math. 1]

$$Φ ( {z}_{k} ) = {\int }_{- ∞}^{{z}_{k}} 𝒩 ( γ ; 0 , 1 ) d γ$$

$${z}_{k} = \frac{f ( {v}_{k} ) - f ( {u}_{k} )}{\sqrt{2} σ}$$

Here, νk, uk are parameters in the k-th comparison, the former indicates that a higher evaluation is being performed by the user, f(x) indicates a function for obtaining a predicted evaluation value for Parameter x, and N(δ;μ,σ₂) represents a random variable δ according to a normal distribution of the average μ dispersion σ2.

As described above, the Bayesian optimization device 10 according to the embodiment compares the N parameters with each other to acquire the _{N}C₂ comparison results, and performs model learning on the basis of the developed comparison results based on the above comparison results. For this reason, learning converges faster and the number of times of comparison by the user is reduced.

Accordingly, according to the embodiment, the Bayesian optimization device, the Bayesian optimization method, and the Bayesian optimization program in which learning converges faster and the number of times of comparison performed by the user is reduced are provided.

Also, the present invention is not limited to the embodiments described above and can variously be modified in the implementation stage within a scope not departing from the gist of the present invention. In addition, each embodiment may be implemented in combination as appropriate and in such a case, combined effects can be achieved. Further, the embodiments described above include various aspects of the invention, and the various aspects of the invention can be extracted by combinations selected from a plurality of disclosed constituent elements. For example, even when some of all the constituent elements disclosed in the embodiments are deleted, as long as the problems can be solved and the effects can be obtained, a configuration from which the constituent elements are deleted can be extracted as an aspect of the invention.

### REFERENCE SIGNS LIST

10 Bayesian optimization device according to embodiment
11 Comparison result developing unit
12 Comparison result storing unit
13 Model learning unit
14 Model storing unit
15 Candidate point selecting unit
16 Candidate point presenting unit
21 Input device
22 CPU
23 Control device
24 Arithmetic device
25 Storage device
26 Main storage device
27 Auxiliary storage device
28 Output device
29 Bus
50 Bayesian optimization device according to known example

1. A Bayesian optimization device comprising:
comparison result developing circuitry configured to receive and develop comparison results input by a user;
comparison result storing circuitry configured to store the developed comparison results;
model learning circuitry configured to learn a model on the basis of the developed comparison results;
model storing circuitry configured to store the learned model;
candidate point selecting circuitry configured to select a candidate point for search on the basis of the developed comparison results and the learned model; and
candidate point presenting circuitry configured to present the candidate point for search to the user.

2. The Bayesian optimization device according to claim 1, wherein:
the comparison result developing circuitry acquires three or more comparison results by comparing three or more parameters included in the comparison results input by the user with each other and creates the developed comparison results on the basis of the acquired three or more comparison results.

3. The Bayesian optimization device according to claim 2, wherein:
the comparison result developing circuitry acquires _{N}C₂ comparison results by comparing N (N is a natural number of 3 or more) parameters included in the comparison results input by the user with each other and creates the developed comparison results on the basis of the acquired _{N}C₂ comparison results.

4. The Bayesian optimization device according to claim 3, wherein:
the comparison result developing circuitry selects M new candidate points (M is a natural number equal to or greater than 1 and less than N) and N-M comparison points for the N parameters.

5. The Bayesian optimization device according to claim 4, wherein:
the comparison result developing circuitry selects, as the N-M comparison points, any one of comparison points of N-M comparison points with the highest evaluation from the past comparisons, random N-M comparison points from the past comparisons, and N-M comparison points that are far from the new candidate points from the past comparisons.

6. The Bayesian optimization device according to claim 1, wherein:
the model learning circuitry uses a Gaussian process for the model and performs learning using the following likelihood function,
[Math. 1]
$$Φ ( {z}_{k} ) = {\int }_{- ∞}^{{z}_{k}} 𝒩 ( γ ; 0 , 1 ) d γ$$
$${z}_{k} = \frac{f ( {v}_{k} ) - f ( {u}_{k} )}{\sqrt{2} σ}$$
where νₖ, uₖ are parameters in the k-th comparison, the former indicates that a higher evaluation is being performed by the user, f(x) indicates a function for obtaining a predicted evaluation value for Parameter x, and N(δ;μ,σ²) represents a random variable δ according to a normal distribution of the average μ dispersion σ².

7. A Bayesian optimization method comprising:
receiving and developing comparison results input by a user;
storing the developed comparison results;
learning a model on the basis of the developed comparison results;
storing the learned model;
selecting a candidate point for search on the basis of the developed comparison results and the learned model; and
presenting the candidate point for search to the user.

8. A non-transitory computer readable medium storing a Bayesian optimization program configured to cause a computer to perform the method of claim 7.
